(19) United States
(12) Patent Application Publication
(10) Pub. No.: US 2013/0073393 A1
(43) Pub. Date: Mar. 21, 2013

(54) COMMUNICATION METHOD AND SYSTEM

(71) Applicant: Marco Nasr, Ottawa (CA)

(72) Inventor: Marco Nasr, Ottawa (CA)

(73) Assignee: MOVITA COMMUNICATIONS INC., Ottawa,Ontario (CA)

(21) Appl. No.: 13/700,615

(22) PCT Filed: May 31, 2011
(86) PCT No.: PCT/CA2011/000747

§ 371 Date: Nov. 28, 2012

(30) Foreign Application Priority Data
May 31, 2010 (CA) 2705966

(51) Int. Cl. H04W 4/00; G06Q 30/02

(52) U.S. Cl. 705/14.58; 455/422.1; 370/328

(57) ABSTRACT

A communications method and system and more particularly, to systems, methods and apparatuses for universal user-to-user communications. A communication system is described which uses a Universal Identification Number (UIN) that identifies each user on the system, encapsulating data that represent the user him or herself. Such data may include, the user's current physical geolocation on the globe; current status (busy, reachable, not reachable); current active endpoint to reach at and preferred method of reach; and an aggregation of all endpoints at which the user can be reached, and their geolocation. The described method and network system thereby can dynamically introduce, adapt, and communicate services (in essence personalize) to each user based on their current location and status. Thus, a user may communicate with another user efficiently without the need to know all of their endpoints or without the need to have multiple communication attempts on multiple devices.

### FIELD OF INVENTION

The present invention relates to communications and more particularly, to systems, methods and apparatuses for universal user-to-user communications.

### BACKGROUND OF THE INVENTION

Existing and traditional communication systems and networks use as a basic block an address that identifies a physical device or a logical account (hereinafter referred to as an “endpoint”) that is associated with a user of the system or network. Examples of such addresses may include:
A phone number that is assigned to a physical telephone associated with the user;
An IP address that is assigned to a computer or smartphone associated with the user; or
An Email address assigned to an account associated with the user. The user from time to time has to pull messages sent either manually or through some automated email software.

Placing telephone calls and communicating in other manners generally requires the user to know which device the called party is most likely to have access to at the time, and to know the specific address of that device. This makes it very difficult to communicate quickly and reliably with others. The calling party often has very limited flexibility in terms of cost arrangements. For example, many cellular telephone contracts are long term contracts (on the order of one or two years) which assess considerable long distance and roaming charges against the user.

There is therefore a need for an improved system, method and apparatus for communication.

### SUMMARY OF THE INVENTION

It is an object of the invention to provide an improved system, method and apparatus for communication.

A universal system of communication is described that allows its users to be reachable at most relevant and convenient endpoints through different means, wherever they are around the globe. The system also allows the user to initiate communication from different devices and locations under one universal identity. This system enables a user to communicate with another user regardless of where the called person is, and what endpoints or devices they may access to.

Furthermore, the communication system described dynamically allocates and communicates services to its users upon physically entering a certain Service Region. A Service Region is a virtual area delimited by location coordinates which are used by the system to describe one's geo-location on earth made of longitude and latitude numbers. A Service Region can be of regular shape such as a circle or an irregular shape delimited by location coordinates. A Service Region can also vary in size ranging from few meters wide such as a store to as large as a country. The bounds of the Service Region can also be changed by the administrator to accommodate any business or contractual needs because they are not limited by geography or infrastructure.

As noted above, existing and traditional communication systems and networks use as their basic block an address that identifies a physical device or a logical account that is associated with a user of the system or network (i.e. telephone numbers, IP addresses, Email addresses). In contrast, the described system and network uses as its basic block a Universal Identification Number (UIN) that identifies the actual person using the system. The UIN is used to encapsulate data that represent the user him or herself. Such data may include, for example:
the user's current physical geolocation on the globe;
Current status (busy, reachable, not reachable);
Current active endpoint to reach at and preferred method of reach; and
an aggregation of all endpoints at which the user can be reached, and their geolocation.

The described method and network system can dynamically introduce, adapt, and communicate services (in essence personalize) to each user based on their current location and status. Thus, a user may communicate with another user efficiently without the need to know all of their endpoints or without the need to have multiple communication attempts on multiple devices. In short, communications are made from one UIN to another UIN, independent of the existing communication infrastructure between them.

According to an aspect of the present invention there is provided a communication system, comprising: a first user communication device associated with a first user; a second user communication device associated with a second user; a communication network; and means for translating communication between the first and second users so as to be carried over the network.

According to another aspect of the present invention there is provided a method of placing a communication comprising: on a mobile device: intercepting a request to place a long distance call, and encapsulating the request to place a long distance call, in a local call to a point of service; and on the point of service: extracting the long distance call from the local call, and placing the long distance call over a VOIP network.

According to a further aspect of the present invention there is provided a method of geolocation-based advertising comprising: an advertiser sending a request to issue an advertisement, to a point of service; said point of service identifying users within a predetermined proximity of said advertiser; said point of service identifying issuing said advertisement to said users within a predetermined proximity of said advertiser.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

These and other features of the invention will become more apparent from the following description in which reference is made to the appended drawings wherein:

FIG. 1 shows an explanatory example of personal and business UINS in accordance with an embodiment of the present invention.

FIG. 2 shows a block diagram of a network component architecture in accordance with an embodiment of the present invention.

FIG. 3 shows a flow chart of a method of service discovery and enablement, in accordance with an embodiment of the present invention.

FIG. 4 shows a state machine diagram of a process for intercepting a call and redirecting to network in accordance with an embodiment of the present invention.

FIG. 5 shows an explanatory example serviced region for “call processing” service in accordance with an embodiment of the present invention.

FIG. 6 shows an explanatory example of different serviced regions in accordance with an embodiment of the present invention.

FIG. 7 shows a flow diagram of a process of initiating a call in accordance with an embodiment of the present invention.

FIG. 8 shows a flow chart of a method of receiving communications, in accordance with an embodiment of the present invention.

FIG. 9 shows a flow diagram of a process of receiving a call in accordance with an embodiment of the present invention.

FIG. 10 shows an explanatory example of a web phone in a social profile in accordance with an embodiment of the present invention.

FIG. 11 shows an explanatory example of web phone button user interface in accordance with an embodiment of the present invention.

FIG. 12 shows an explanatory example of an interface for requesting support using a menu item in accordance with an embodiment of the present invention.

FIG. 13 shows a flow diagram of a process of support call software in accordance with an embodiment of the present invention.

FIG. 14 shows an explanatory example of a serviced region for “a long distance call” service in accordance with an embodiment of the present invention.

FIG. 15 shows a flow chart of a method of placing long distance calls in accordance with an embodiment of the present invention.

FIG. 16 shows a flow chart of a method of interactive communication in accordance with an embodiment of the present invention.

FIG. 17 shows a graphic and screen capture to illustrate an interactive communication in accordance with an embodiment of the present invention.

### DETAILED DESCRIPTION

One or more currently preferred embodiments have been described by way of example. It will be apparent to persons skilled in the art that a number of variations and modifications can be made without departing from the scope of the invention as defined in the claims.

One of the fundamental concepts of the invention is that each user is assigned a Universal Identification Number (UIN). A user can be an individual or an entity such as a business, an organization or a store. The user UN serves as an identification and authentication mechanism whenever the user needs to receive a communication request or to access the system to initiate communications. Communications may include but are not limited to voice calls, video calls, or data messages (https, SMS).

All of the user communication endpoints and their geolocations are populated dynamically in the network under his/her UIN. Communication endpoints can be of any type or protocol, including but are not limited to PSTN numbers, mobile numbers, email addresses, SIP URLs, facebook id, Linkedin id, and IP addresses. Dynamic population of the communication endpoint fields may be achieved in multiple ways, including for example:
the user submitting information through a website;
the user transferring existing owned numbers by means of Local Number Portability (LNP);
the system assigning a physical routable number and auto-estimating geolocation;
through an explicit login mechanism such as in the sip protocol or https protocol; or
using an intelligent software client that resides on a communication endpoint device such as a mobile phone. The software client monitors the current SIM number and geolocation, then updates the network with any changes.

The user chooses one endpoint to be the primary endpoint used for outward caller ID purposes. The system maintains a large relational database containing all endpoint locations and the relations between them and their corresponding UINs. This component of the system is called “Location Service”.

The user can assign an identity or role description to a UIN. Therefore a user can have multiple UINs with each one describing a different function or identity of the person. For example, a person can have two UINs, one with the identity description of “personal identity”, and a second UIN with the description of “business identity”.

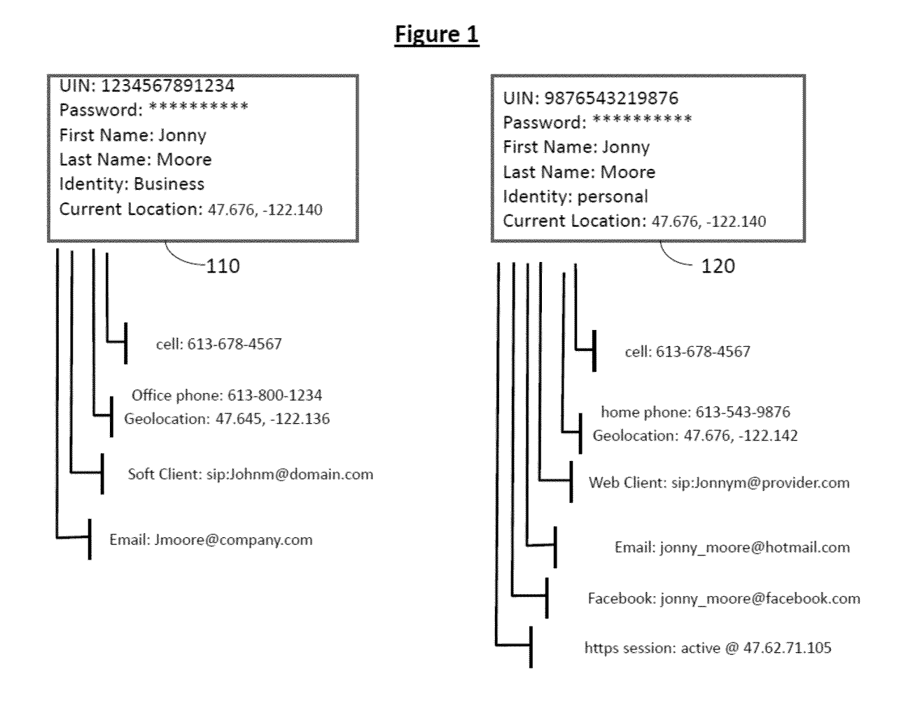

FIG. 1 presents an exemplary user with two identities and the pertaining endpoints. The two UINs are unique and different from one another. The “business” identity of the user 110 contains: UIN, password, first name, last name, the particular identity and current location. It also includes contact information for this user/identity, of: cellular telephone number, office telephone number and geolocation, soft client address and email address. Similarly, the “personal” identity of the same user 120 contains: UIN, password, first name, last name, the particular identity and current location. It also includes contact information for this user/identity, of: cellular telephone number, home telephone number and geolocation, web client address, email address, facebook address, and https session. Of course, different fields may be provided and populated for different individuals, applications, social networks, de-vices, etc.

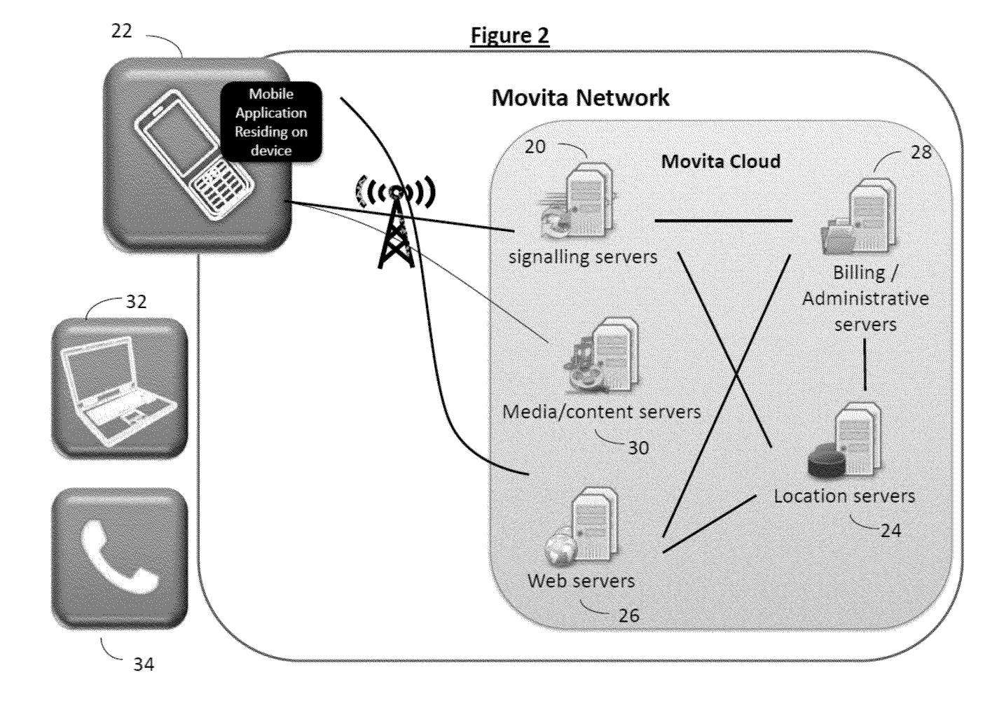

FIG. 2 presents an exemplary network diagram with the primary architectural components of the system of the invention and their interrelationships. The system and network described is composed of many components that use a client-server architecture. The components either reside in the cloud or on the mobile cellular phone using mobile Applications, all of the components together forming the network. The network has been designed using the latest security, reliability, and efficiency paradigms available. For example, TLs secure communications may be used for Internet communications.

The signaling server 20 is the server that stays in constant communication with all of the mobile apps that are on mobile devices 22, the mobile apps being considered part of the network. The signaling server 20 communicates with the mobile devices 22 to determine whether access is required on their part or whether it is necessary to respond to requests coming from them. The signaling server 20 is also responsible for any signaling coming from other clients such as, VOIP phones, ATAs or laptops. It uses specific protocols such as HTTPS for security or the SIP protocol.

Implementation of the signaling server 20 may include use of the Mobicents SipServlet V1.2, which is a sip servlet server application framework. The network logic relating to call traffic handling makes use of this component by linking to it. The Mobicents product need not be altered or extended in most applications. It can currently be found at this URL: http://www.mobicents.org/products_sip_servlets.html

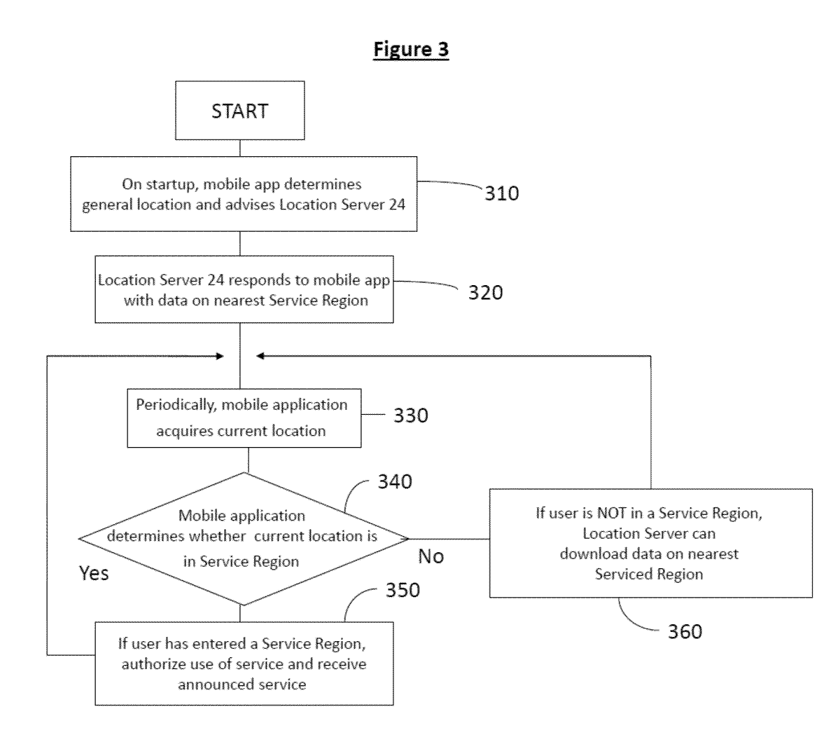

The mobile app on the mobile device 22 is constantly monitoring the location of the mobile device 22. For security and privacy purposes, the current implementation of the invention does not send the exact location of the mobile device 22 to the Location Server 24, but rather, it is sufficient to communicate the general area or region to the Location Server 24. The handling of locations and regions is described in more detail with respect to FIG. 3, but in short, the mobile application sends the general location to the Location Server 24 and the Location Server 24 returns data regarding the local Service Region or Regions. Thus, the mobile application itself is able to make decisions with regard to Service Regions, relying on this information.

The Location Servers 24 manage arrivals and departures to and from the Service Regions, monitoring where the users are, and whether they have access to service. They also manage the best and most relevant way to communicate with other users using their UINs and their specific endpoints.

The Web Servers 26 provide the main website for the service, including information and interfaces for setting up new accounts and downloading the mobile application. The Web Servers 26 also host a user's online account.

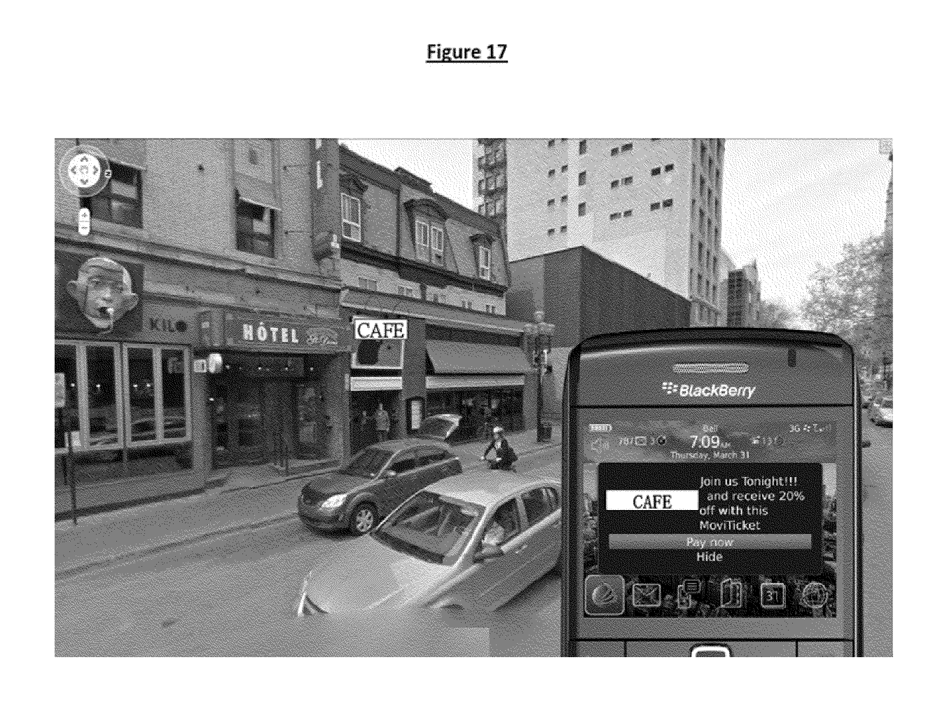

The Billing/Administrative Servers 28 manage user accounts and related financial transactions. Users may, for example, pay for system services automatically, using electronic payment systems such as Paypal or credit cards. As well, users may charge third-party communication or online services to their UIN accounts, or receive credits against it. See, for example, the discussion regarding advertising and coupons, with respect to FIG. 17. The Billing/Administrative Servers 28 makes this possible by defining the preferred method of payment and financial information under one's own UIN. The database storing all user relational data is also maintained in the Billing/Administrative Servers 28

The Media/Content Servers 28 store and manage content such as location-specific advertising. Because the system can make decisions based on geolocation, contains user profile information and preferences, and employs Service Regions, it is a very efficient way to implement targeted advertising. The system can, for example, direct advertising to the mobile devices of users in a specific geographic location (such as in a shopping mall), with a particular profile (such as men over the age of 40 years). The Media/Content Servers 28 store and manage the related content (images, text, video and/or audio/video) and other services.

Other servers such as various application servers may also be included as part of the network.

Implementation of the invention may include use of the Google Web Toolkit, GWT V1.7, a toolkit that facilitates web application development. This component was used to develop the client server communication process for customer web accounts without altering or extending it. The GWT product can currently be found at this URL: http://code.google.com/webtoolkit/

The process and systems used for service discovery and enablement is shown in the flow chart of FIG. 3.

Upon initial launch, the mobile application client determines its location coordinates, and then updates the Location Service 24 with the current location 310. Location Service 24 responds with a list of serviced regions and their associated data near the user current location at 320.

A Serviced Region refers to a pair of “Point of service” and the corresponding region where the service is active or provided. If a user location is found to be within a Serviced Region, then the client software uses the corresponding point of service information to access announced service. Serviced region data refers to a data structure containing the serviced region delimiting location coordinates, point of service, and the “announced service” with its parameters.

Point of service is a pair of “announced service” and the corresponding physical or logical routable address that a user can reach to get access to service. Point of service also describes the method of accesses to an “announced service”, which can be a voice call or a data request. Examples of addresses may include but are not limited to:
a voice service number;
an SMS service number;
a website or data URL; or
a stored address.

An Announced service is a function the system can perform for or on behalf of the user. Examples of services are:
calls processing gateway;
Coupon handler point;
Advertisement distribution point; or
Payment handler point.

Periodically, the client acquires the current geolocation using location determination technologies built-in to the mobile device 330. Location determination technologies on the device may include:
Global positioning system (GPS)
Trilateration
Triangulation
Cellular tower Id
Accelerometer

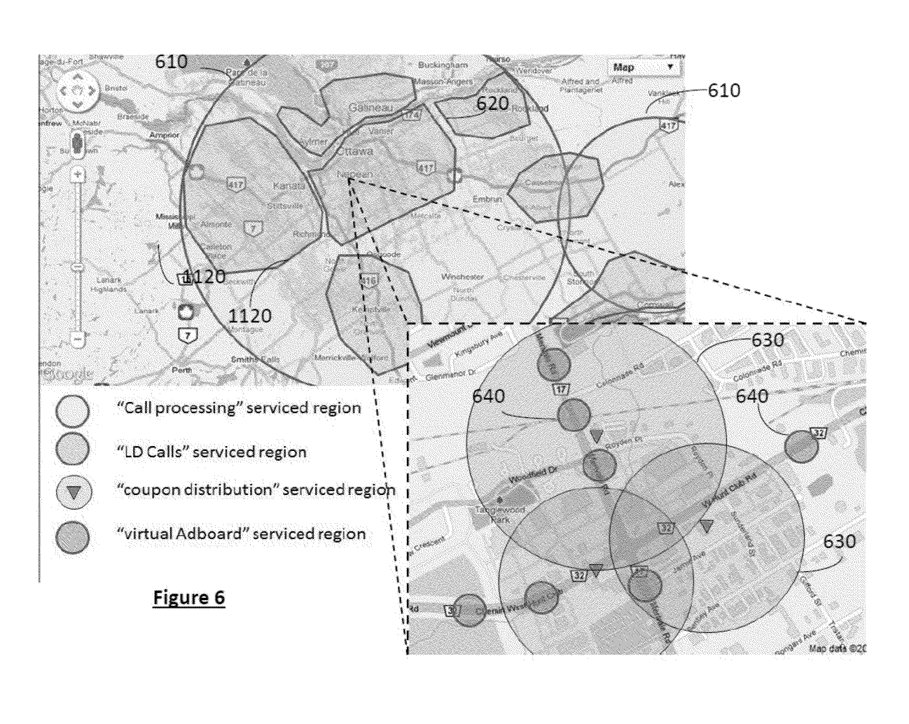

Most new mobile devices 22 have built-in GPS, and even those without GPS may provide location information via the API of the mobile device 22. If a mobile device 22 has neither of these, then a software module may be written to determine the device location. If none of these are available, the mobile application may simply ask the user to provide the location, or confirm it. The user may be presented with a list of countries to select from, then provinces/states, then cities/towns. The degree of precision required depends on the service being requested. Some services may be uniform across a city, such as long distance services, while other services may require much greater precision, such as a coupon service (see FIGS. 6 and 17).

The mobile application then verifies whether its newly acquired geolocation lies within a serviced region boundaries using a computational geometry algorithms such as but not limited to Graham-Scan (related to convex hull) at 340. This is possible because the mobile application has received data on the local service regions at 320.

If the client determines that it has entered a Serviced Region, then it communicates with the point of service at 350 to authenticate and authorize use of service. If authorized, the client receives the announced service and any properties relevant to execute the service. Authentication/authorization is done by transmitting data to the point of service such as the User's UIN, the device that they are on and possibly a password or passphrase. In return, the point of service identifies the services that person or UIN is authorized to receive from the signaling service, and confirmation they are a user of the system.

If the client determines that it no longer lies within the current Serviced Region, then the client may communicate with the Location Service 24 to download data on the nearest Serviced Region.

Descriptions of several exemplary scenarios follow.

### Communication Intercept for the Purpose of Redirecting Communication Flow to a Value Added Service Provider

This process provides the ability to intercept outgoing communications such as voice calls, and SMS messages destined to a routable/reachable address, to be redirected through a network access point for the purposes of value added services and cost efficiency. That is, when the user attempts to place a telephone call (for example), the software client on the mobile device 22 will either let the call proceed in the normal fashion, or it will intercept the call and route it to a network access point on the inventive network. For example, if the user places a long distance call from his cell phone, the system may intercept the call and route it first to a local network access point which forwards the call via Skype or the PSTN, to the destination. This allows the user to avoid long distance charges to his cell phone account.

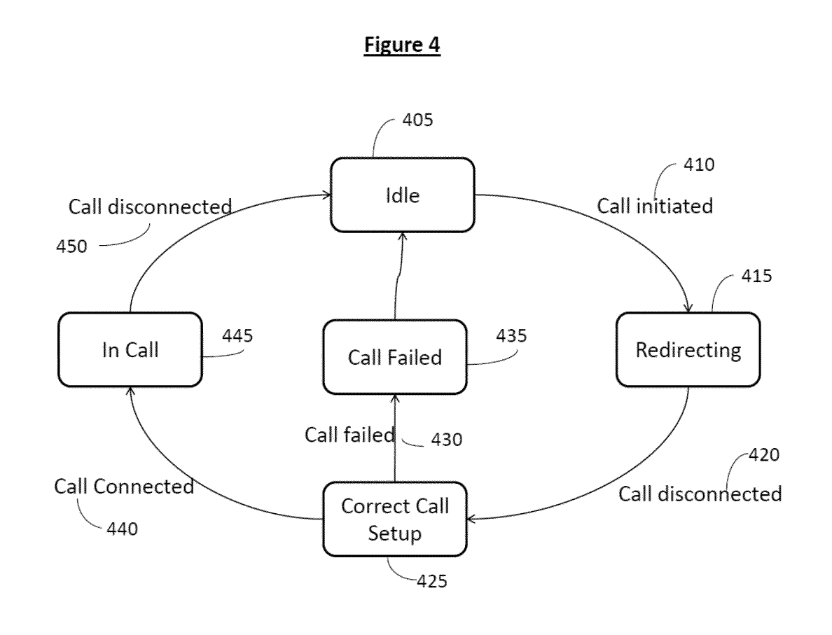

This process is shown in the state machine diagram of FIG. 4. The process begins when the User initiates a communication 410 from the idle state 405. This can happen from multiple points on an endpoint device including, for example, from an address book, from a history list, or by manual entry of a destination address.

The software client detects communication initiation 415. This can be achieved through multiple ways, including, for example, through device supported APIs, keystroke detection, or through low level communication event listeners. Note that the software client may be on any one of the User's devices (i.e. his/her personal computer or laptop 32, mobile device 22, desktop VOIP telephone 34, etc.) The software client then interrupts the communication flow 420 and alters the destination address to be the network access point. The software client authenticates with the network using its UIN, and then communicates the original intended destination address and the message (in the case of data communication). That is, the placed call or data message is encapsulated in a new message that is sent to the network access point. The network access point parses or disassembles the message and allows the communication to proceed 425 with whatever advantageous routing or value added service is determined. As noted above, this may include, for example, creating a local cell phone connection between a mobile device and the network access point, and a VOIP (voice over IP) connection from the network access point to a called number.

If the communication attempt fails 430, then the user will receive an appropriate failure message 435, such as a busy signal, “invalid address” or “not in service” message. Processing then returns to the idle state 405. If the communication attempt is successful 440, then the user participates in the communication 445 until it is disconnected 450. Processing then returns to the idle state 405.

When communication is completed, the software client updates device history logs with appropriate information of original destination number, the status, and duration if applicable.

Note on multiple identities: before a user initiates a communication in step one, the user has the option to select under which identity this call will be made if there are multiple identities configured. The selection can be done by means of a menu item or an Icon selected. The client uses the appropriate UIN to authenticate depending on the identity selected.

Initiating Communication from a Smartphone:

The system of the present invention allows users to initiate communication from different devices and locations under one universal identity using the IAN; and to be reachable at most relevant and convenient endpoints through different means regardless of where they are, by dialing any of the registered endpoints or dialing the UIN itself. This system enables a person to call another person irrelevant of where the called person is present at which location or endpoint.

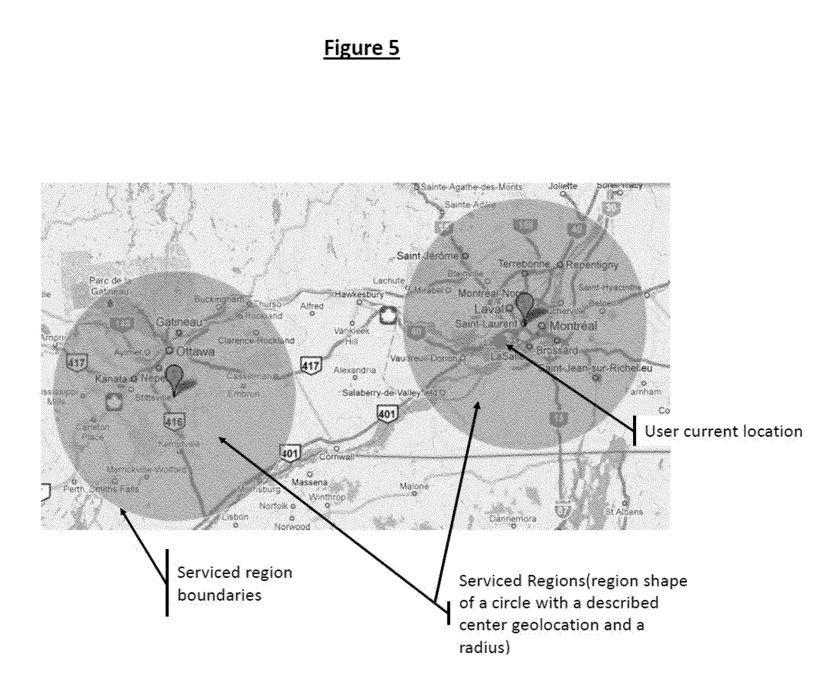

When a user is located within a serviced region and places a call from his or her cell phone, the system will intercept the call and route it first to a point of service designated to process calls which forwards the call through the invented network to destinations such as a Skype user, PSTN, or another user of the system. The solution requires the invented mobile application client running on an endpoint location device and the invented network with a reachable point of service. FIG. 5 and FIG. 6 illustrate an example serviced region for “call processing” that services the Ottawa Region. Note:
the largest regions 610 are “Serviced Regions”, that is, areas in which a point of service is available. While these are shown as single, large circles (region shape of a circle with a described center geolocation and a radius), they will generally not have such uniform boundaries because for a mobile device (for example), they will be determined by the location of cell phone towers and related communication infrastructure;
the smaller regions 620 are long distance call serviced regions. That is, areas in which long distance calls can be made by a mobile phone at no cost to the user, because a local cell call can be made to a point of service which forwards the call over a VOIP network (for example);
the smallest regions, the “coupon distribution” regions 630 and “virtual adboard” regions 640 are defined by the administrator and are associated with the geolocation/proximity-based advertising services (see the description of FIGS. 6 and 17 which follow). In short, coupons and advertising can be pushed to system users when they enter these regions—regions which are physically close to stores, restaurants and other advertisers.

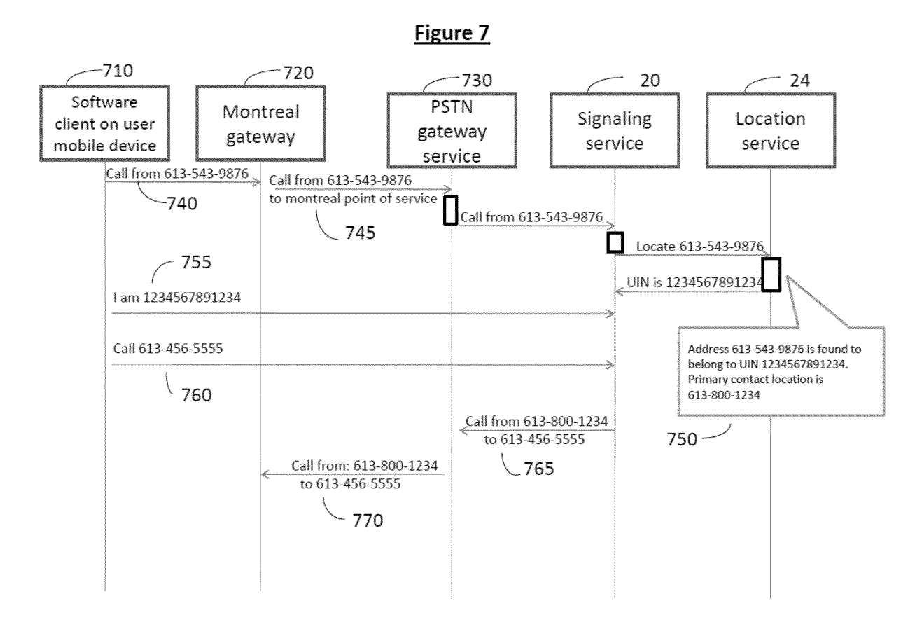

FIG. 7 illustrates an exemplary process flow diagram for performing a communication initiation process for a voice call, from a smartphone.

Firstly, the user must be present in a serviced region with an announced service of type “call processing” determined by the method described in FIG. 3. In short, upon the user placing a cellular call to 613-456-5555, the invented mobile application 710 intercepts the call and sets up a communication link 740 with the nearest gateway, in this case, the “Montreal gateway” 720 using the local telephone number for the gateway 720. The Montreal gateway 720 passes the call request (including the calling number) along to the point of service for the Service Region 745, which includes a PSTN gateway 730, a Signaling Server 20 and Location Server 24. It is not necessary that these servers 20, 24 are physically separate or exist in the same physical location. It is preferred that they all exist on the “cloud”.

The point of service obtains the user UIN from the Location Services 24 using the calling number 750. This is used to authenticate the user identity on the using the calling number and the user UIN 755. The mobile application 710 then communicates the intended action of calling a destination endpoint 760. The invented network software, residing at the service provider location (possibly on an enterprise server of some kind), authenticates the endpoint device, locates the appropriate UIN related to the source endpoint devices by means of the Location Service 24, uses the source primary endpoint contact as the number in caller ID, then the network processes the intended action of placing the call to 613-456-5555 (see 765, 770 in FIG. 7).

In the example of FIG. 7, a call from 613-543-9876 to 613-456-5555 from the user's mobile device 22/software client 710, is routed to the nearest point of service (Montreal gateway 720), which then communicates the original intended destination address upon authorization using UIN. Rather than identifying the user's current location of 613-543-9876 as the caller ID, the user's primary endpoint contact of 613-800-1234 is shown as the caller ID number.

While this example describes the placing of a telephone call, a point of service address for an announced service of type “call processing” can include a voice service number, an SMS service number, a website, a data URL, or similar communication. Setting up a communication link with the system can, for example, take the form of making a voice call, starting an SMS session or starting a data session with a point of service. If the user is within a serviced region, it is generally preferable to set up voice calls to the point of service and to communicate bidirectionally with the network using dual tone multi frequency (DTMF) as it typically has the best user experience and lowest cost to the user. If the user is outside of a serviced region, it is generally preferable to communicate using a data session (such as SMS or http) to the nearest network access point and to communicate bidirectionally with the network using data messages, as it provides lowest cost to the user. These preferences may change over time as technology evolves and communication service offers change.

In the case of a user initiating communication and having multiple identities, in the authenticating step 755, the client needs to use the appropriate UIN of the intended identity to authenticate, as determined by the process described with respect to FIG. 7.

### Receiving Communications:

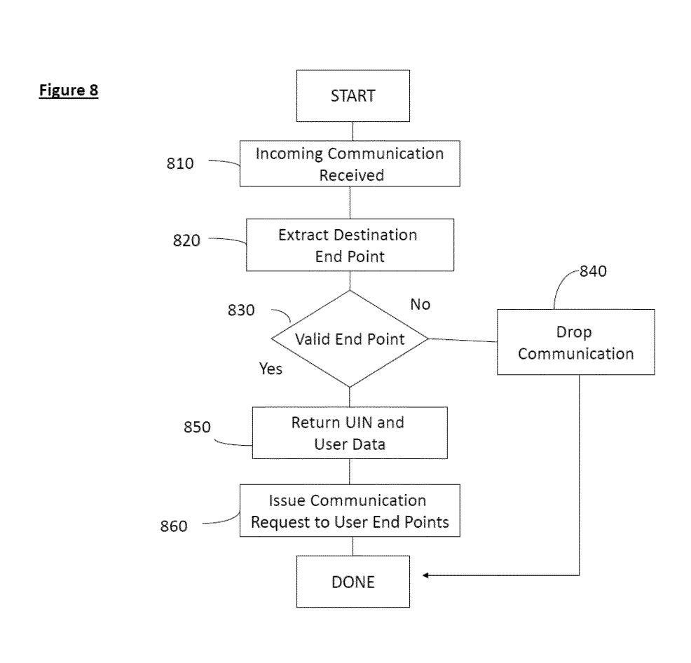

When an incoming communication request arrives at the network, the system determines which destination endpoint location should receive the communication by means of the process shown in FIG. 8.

The process begins when the network receives the incoming communication request by means of a voice call or a data message (SMS or http) 810. The system then extracts the destination endpoint location from the communication request 820. The system refers the call to the Location Service component 24 to determine whether the destination endpoint location is a valid endpoint in the system 830. If the call is not for a valid endpoint in the system, the call is dropped 840. The PSTN gateway 730 receives the initial call by directing all of the users' PSTN numbers to the gateway, either through LNP, or by call forwarding to the network. Therefore, the PSTN gateway 730 is guaranteed to receive the initial call even when a new user account is set up.

If the call is for a valid endpoint in the system, the Location Service component 24 returns the UIN and the identity description to the Signalling Server 850, if this information is available. The location service also returns a list of endpoints that are active and near the user's current geolocation by a configurable distance, fifteen meters as an example.

The network initiates simultaneously a communication request to each returned endpoint under the same UIN 860. These communication requests can take the form of voice calls or data messages (SMS or http for example). As per the methods and process described with respect to FIG. 8, the network maintains the latest geolocation for each endpoint location. Hence, it only routes the communication to the nearest and active endpoints resulting in a very efficient and user friendly system.

In the case of a user with multiple identities, if an identity description is available in the determining step 830, the network manipulates the communication request to append the destination identity to be used by the software client to show the user which identity this communication is intended to. The best mode of implementing this method is using the caller ID name or number on the outgoing leg from the Network. The software client residing on the receiving devices extracts the identity from caller ID name and shows the appropriate representation to the user.

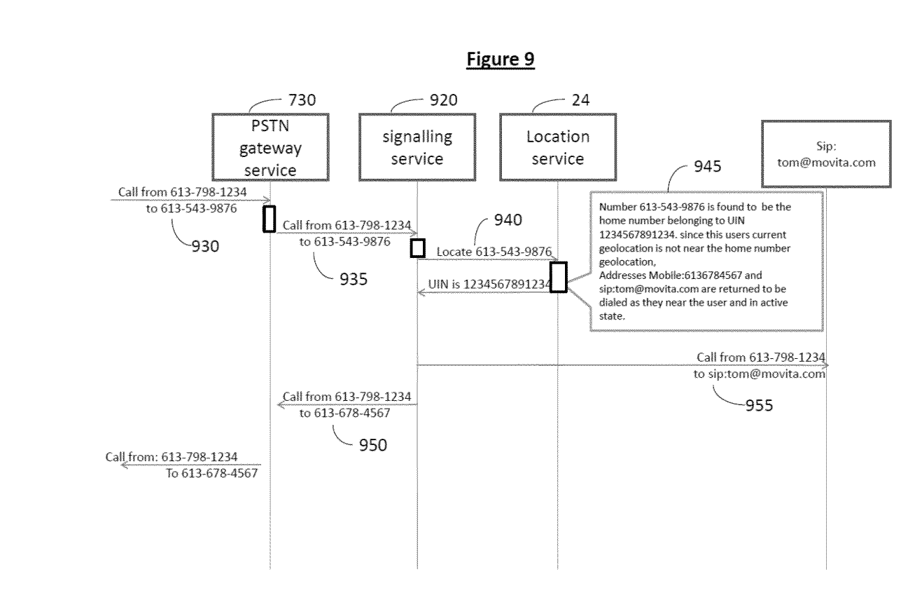

FIG. 9 illustrates an exemplary process flow diagram for performing a communication reception process for a voice call. In this example, a call is received at the PSTN gateway 730 from 613-798-1234, identifying the destination number 613-543-9876 (see 930). The PSTN gateway 730 forwards this call to the signalling services 920 (see 935), which extracts the destination number 613-543-9876, and refers it to the Location Server 24 (see 940). The Location Server 24 determines that 613-543-9876 is the home telephone number belonging to UIN 1234567891234. As the user current geolocation is not near the home number geolocation, mobile number 613-678-4567 and sip:tom@movita.com are returned as the active endpoints which are near the user 945. The network then initiates simultaneously a communication request to both mobile number 613-678-4567 and sip:tom@movita.com 950, 955.

Initiating Communication from a Webclient to a UIN Destination for the Purpose of Person to Person Communication

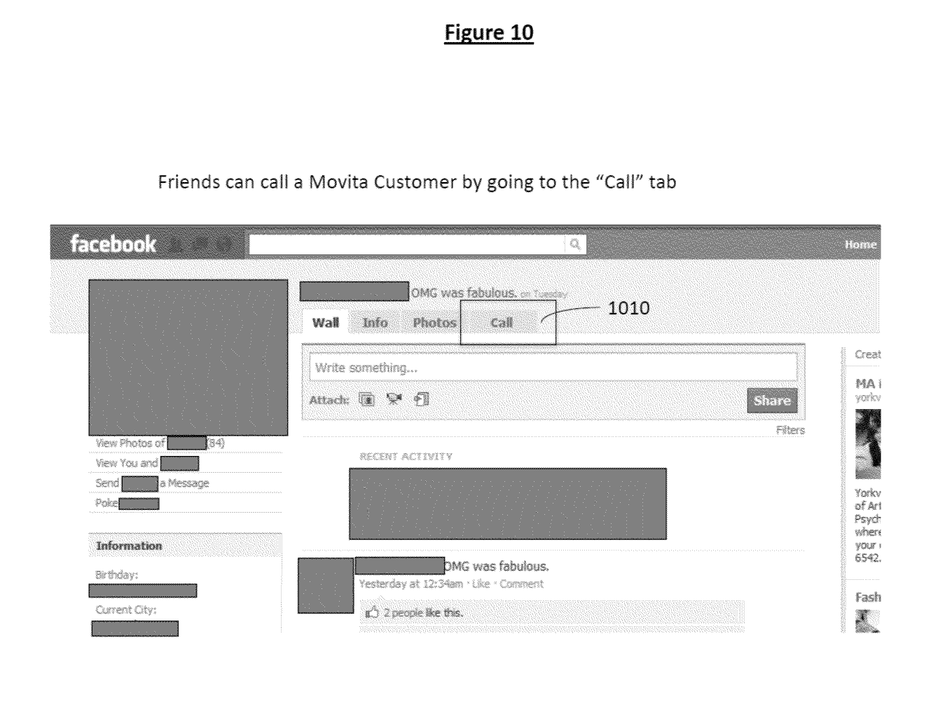

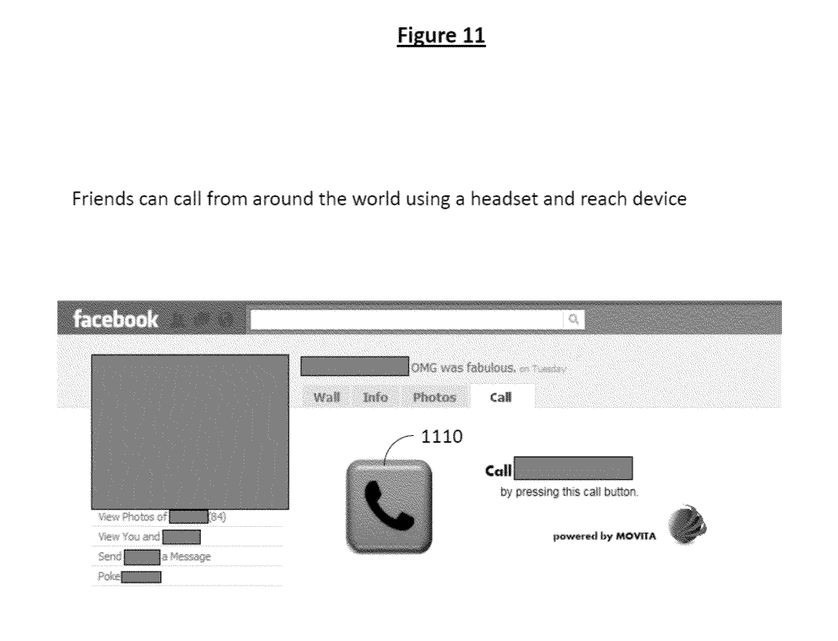

When a user intends to be reachable wherever they are located and to simplify the task for others in getting in touch with them, the user exposes a web Phone on any or all of their own social profiles as needed. For example, FIG. 10 illustrates a “call” tab 1010 on a user's facebook page providing a web phone for others to get in touch with the user. Example social profiles include but are not limited to: Facebook, LinkedIn, and Twitter. The exposed web phone enables others to dial calls to the UIN of the exposing user with a click of a button. FIG. 11 provides an example web phone button user interface 1110. The solution requires the invented Web Phone application and the invented network.

If someone clicks on the “call” tab 1010 of FIG. 10, the call tab 1010 opens up the screen of FIG. 11 providing a web phone user interface 1110, The web phone has a built-in VOIF engine. When the phone button 1110 is clicked in FIG. 11, it instructs the VOIP engine to dial the UN of user hosting the web phone. Only a headset is required from the person who is calling the user hosting the web phone. For example, clicking on the phone button 1110 will cause a Java script to execute, which launches the calling party's built-in VOIP engine, to place a call to the called party. When the VOIP engine is launched, it can automatically dial the called party by sending appropriate instructions to the VOIP engine through its API. Once this occurs, the balance of the process is as described above with regard to “Receiving Communications” section. Most social networks such as Facebook, are easily customized to add icons and associated Java script such as this.

### Specific Scenario—Support Calls:

The above method and client-server architecture renders certain possibilities simple to achieve. In this scenario a company can provide support services through a mix of support request types such as voice calls, email, Instant messages and SMS, All support request types line-up in one queue in order of arrival to be serviced.

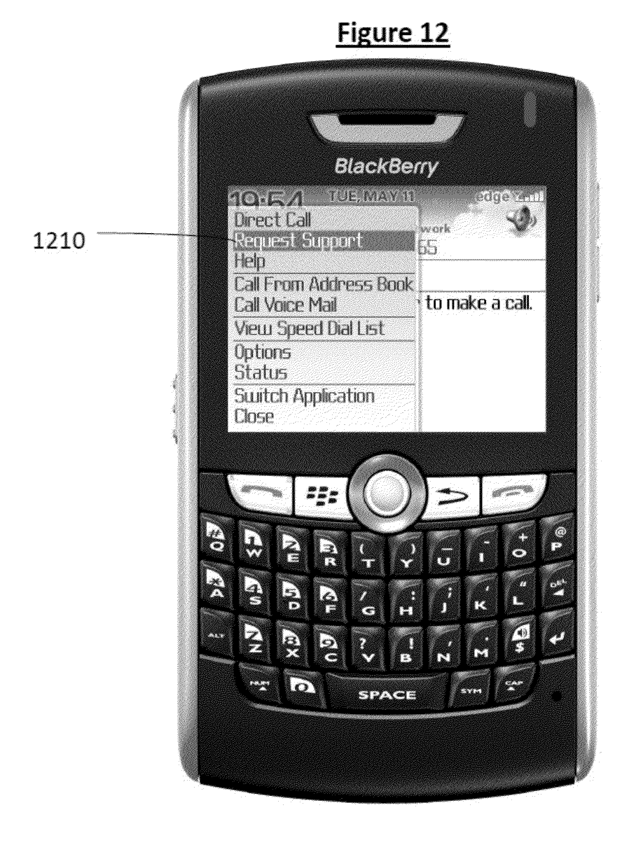

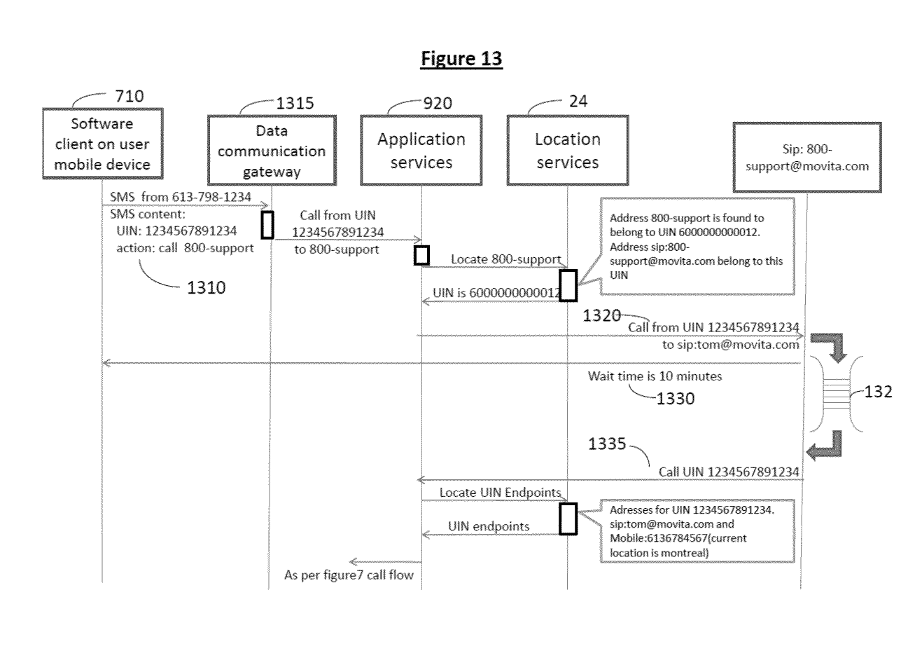

A user by means of his/her mobile device can request support services, for example, by clicking on an icon on their device, or selecting a menu item 1210 as shown in FIG. 12. FIG. 13 illustrates an example of a process for handling a support call from a user.

When the user clicks the menu item labeled “request support” 1210, the request support function in the software client 710 of the mobile device 22 is activated. The software client 710 initiates communication with the nearest point of service through voice, SMS or HTTP 1310. These communications are directed to the appropriate gateways, such as the data communication gateway 1315, which pass the communication along to the signalling server 920.

The client software 710 identifies itself to authenticate with the network using the user's stored UIN. The UIN is stored and protected in the device's local database. The combination of the endpoint device address and UIN are used for authentication purposes, therefore the UIN should not be shared. Other security provisions could also be added if desired, such as a password, passphrase or one-time-password.

Once the request has been authenticated, the call is passed to a supported, pre-registered, location address 1320, and the call is placed in the priority queue 1325. The client may then be notified by network of the remaining wait time (possibly through SMS) 1330.

When it is time to service the support request, the network initiates communication with that specific UIN 1335, as described above with respect to FIG. 9.

The best mode of implementation for the support call system is generally to use voice calls as a communication channel between the software client and network. The network could be implemented using Sip Servlets specifications to combine data and voice communications.

In the attached figures the UIN is shown to comprise 13 decimal characters but it may have any length that is sufficient to support the expected number of users and to provide enough diversity to be secure (i.e. sufficient length to prevent random attacks from being successful).

### Long Distance Calls Termination Service:

The system of the present invention also provides the ability to intercept outgoing voice calls to be redirected through a point of service for the purposes of value added services and cost efficiency. That is, when the user attempts to place a telephone call (for example), the software client will either let the call proceed in the normal fashion, or it will intercept the call and route it to a point of service of the invention. For example, if the user is located within a serviced region and places a long distance call from his cell phone, the system will intercept the call and route it first to a point of service designated to process long distance calls which forwards the call through the invented network to destinations such as Skype user, PSTN, or another user of the system. This allows the user to avoid long distance charges to his cell phone account and the ability to dial long distance calls from any device under one account. This solution requires the invented mobile application client running on an endpoint location device and the invented network with reachable point of service.

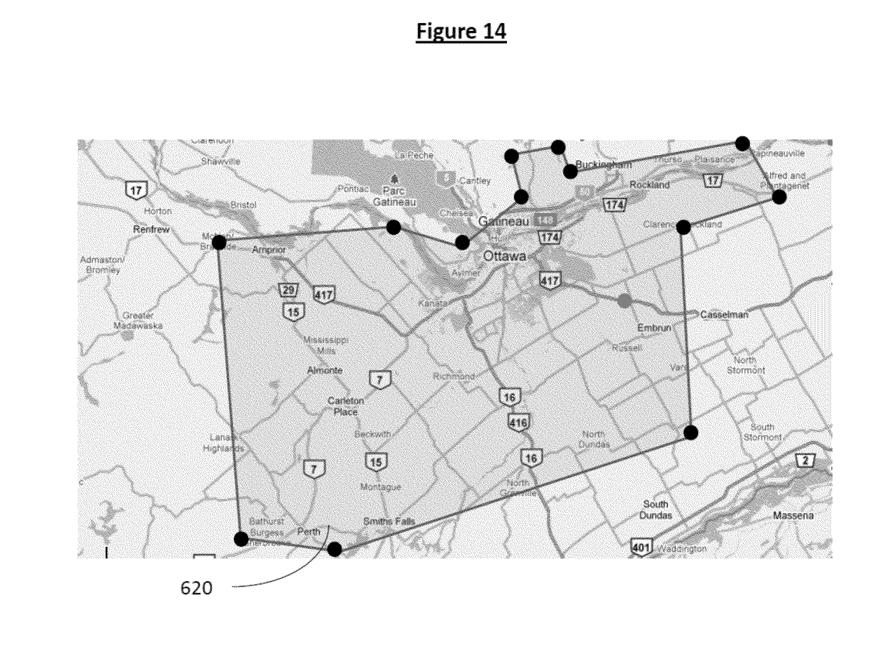

As noted above with respect to FIG. 6, the region in which such a service is available will not necessarily be a neat geometric shape. FIG. 14 presents an exemplary long-distance serviced region.

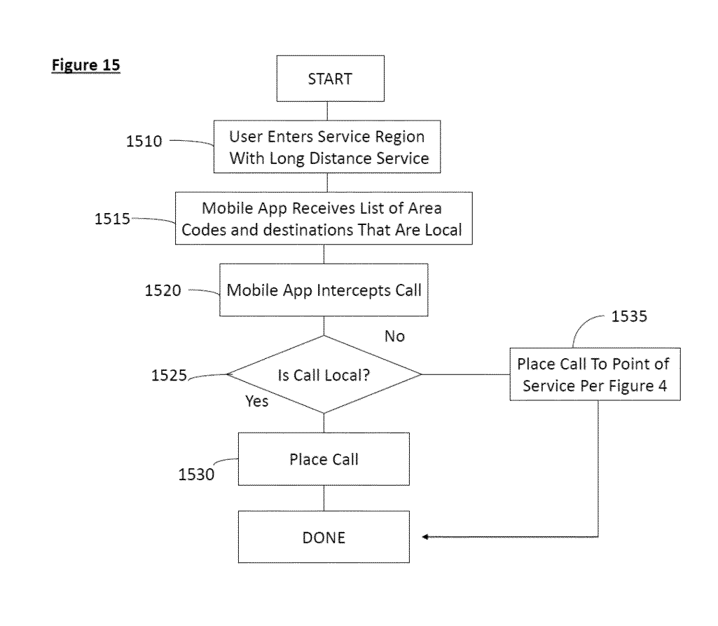

An exemplary method for implementing such a feature is shown in FIG. 15. For a user to place a long distance call, they must be present in a serviced region with an announced service of type “LD calls service” determined by the method described with respect to FIG. 3. When the user enters a service region with such a service 1510, the mobile application receives a list of area-codes and the corresponding destinations that are considered local calls to this specific region 1515.

Upon the user placing a cellular call, the invented mobile application intercepts the calls as described with respect to FIG. 4 1520. The mobile application then compares the intended destination to the list of local destinations 1525. If the intended destination is found to be a local call, then the call is processed in the normal manner 1530. If the intended destination is found to be a long distance call, then the software client sets up a communication link with the determined network point of service identified in the serviced region data 1535. The long distance call is then placed through the inventive network as described above with respect to FIG. 4.

### Immediate Vicinity Real-Time Potential Customer Communication Service

The system of the present invention also allows users to initiate interactive communications at certain geolocations, and to automatically receive interactive communications when users come within a specified proximity of a geolocation. This service provides a push technology and is intended for businesses to improve communications with potential and existing customers located within the specified vicinity (i.e. coupons, advertising, information, etc.)

Interactive communication described with respect to this application refers to a sequence of request and response transactions. An example of a request may be an image with accompanying text, a video, or a question with a list of possible responses. A response may be a choice from a presented list, free form text, or a selection.

The interactive communication described by the present invention employs push technology, as a way to bring in new customers. When the user is in the vicinity of a certain geolocation, service options exist that are associated with the location. Conventionally, the users have to click and sign up themselves or check in at a certain location to see the offerings that are associated with the location. This requires users to initiate the actions or to obtain communication information themselves. In contrast, with the Location Service of the present invention, the system of the present invention provides a push technology for users to interact with other users.

For example, the process described in the present communication system allows users to choose exact communications and attach them to certain geological locations with a certain radius. And for other users that are walking by that geo location, they will receive that interactive message as a push message. Such a system offers many advantages, including relevancy, immediacy, and the attraction to new customers.

Such a system enables interactions with users that are most relevant to the intended purpose of the service. Current methods could send their advertisements through SMS, however the sender would not know where the receiver is or whether the mobile device is off. Moreover, there is usually a disconnect between the many advertisements on the web and a user at a specific area without a coupon or an access to the web. With the offering of the present invention, the interactive communication is sent only to people who are walking by and who might be looking at restaurants. This targeted communication also saves bandwidth and resources in the system.

Another advantage of this application is the immediacy. As a business owner of a restaurant, he or she would usually develop advertising campaign, provide some promotional items and either submit to newspapers or to Google ads where he or she would create accounts and the users would receive it online after a certain time. However, this does not address the immediate need to fill in the restaurant on a slow day. The solution of the present invention is immediate as the user may set up an interactive message and it becomes live on the network right away. Other users who are walking by within a few seconds or minutes will receive the message.

Yet another benefit is attracting new customers. The receiver of the interactive communication could be a person walking by, a potential customer, or a user that has had no prior history with the business. The system of the present invention provides a new way of attracting such customers, especially new customers. It is also beneficial to the customers to know about new services in the region or new business in the region. This service provides effective push technology and is intended for businesses to improve communication with their customers or potential customers, bringing new customers in the door.

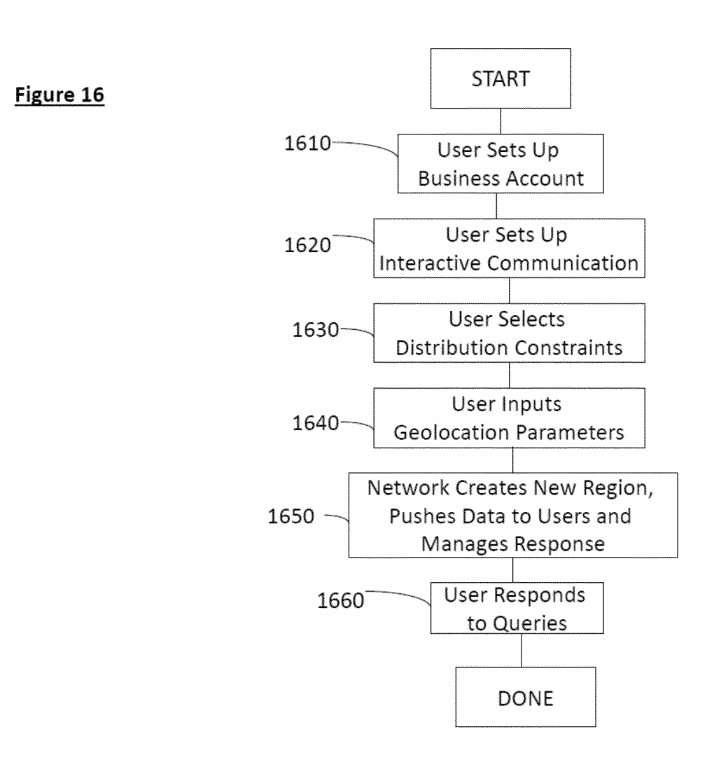

A process for placing an interactive communication message is presented in the now chart of FIG. 16.

Users can sign up as business owners 1610. This system creates a web portal, and uses an online account for users to log in and invoke actions in the system.

A user who has signed-up for this service may then login to their online account to create an interactive communication transaction 1620. As part of creating the interactive communication, the user submits any text, images, videos, or a combination of all that will be presented to users who will consume the interactive communication. The submitting user also has the option of requesting a response and can provide a list of possible answers or actions for the consumer to use.

The submitting user then selects the constraints for distribution of the interactive communication 1630. Possible constraints include but are not limited to: targeting the receiver (e.g. male, female, youth), or situation (e.g. user entering the area or building, leaving the area or building, having stayed for 5 min within the serviced region, etc.) These targeting criteria are available because the users may provide personal information when they set up their accounts. It is not necessary for the distributor of the interactive communication to see any of this personal information, so the users privacy is maintained. The situational criteria is available because of the geolocation capability of the system.

The submitting user then chooses the geolocation and the size of area to cover the users who will receive this interactive communication 1640, and their interactive communication is sent to the network.

The invented network creates a new serviced region with the specified geolocation and size, delivers a point of service that distributes the interactive communication, and manages responses back to the submitting user's UIN 1650. By setting up the new serviced region, the interactive communication will be pushed to any user who is in the new serviced region or who enters the new serviced region. The submitting user then awaits responses received under their UN and communicates with any other users in the usual manner.

Example applications of placing an interactive communication include the following:
1) A store owner placing an interactive communication within their store and with the size of the store. The interactive communication welcomes users as they walk into the store and requests customer feedback as users walk out of the store.
2) At GPM on a slow day, a restaurant owner places an interactive communication in real time for users around the restaurant by a radius of 1.2 kilometres. The interactive communication presents an advertisement saying “join tonight for 20%” with a response to “Pay” as a way to redeem the coupon. (see FIG. 17). In particular, FIG. 17 illustrates a restaurant called “Cafe” in Montreal that when a user was walking by, the user received the pop up coupon with a picture, text and a list of options in the response. The user walked in and when it is time to pay the bill the user could click on “pay now” to redeem the coupon. Because the basic communication is between two UINs, funds transfer from one UIN to the other takes place easily. For example, when users sign up for the service, the users can submit their Paypal ID or credit card information, which is part of the billing server process. When it is time to redeem a coupon and pay the bill, the user would accept the dollar amount assigned by the provider of the interactive coupon by entering their password. The provider of the interactive coupon can optionally assign a dollar amount while setting up the interactive communication if it is a fixed amount. Alternatively, the provider can assign the dollar amount during the interactive communication transaction by means of a real-time generated QR if the dollar amount is variable as in the restaurant example.
3) A department store placing an interactive communication within the store with a size of five meters in radius a new product. The interactive communication introduces the product and provides a promotion to male users.

### Options and Alternatives

Additional options may include the following:

1) the use of this network and process in road construction live announcement and redirection, and in traffic congestion live redirection;
2) the use of this network and process for the purpose of auto Identification of incoming users into medical establishments and auto loading of their records and history;
3) the use of this network and process in the hospitality and tourism industry for the purpose of auto introducing sites and amenities;
4) the use of this network and process in retail industry for the purpose of coming within a range of an item and purchasing it on the spot and optionally delivering it at users address without standing in a line;
5) the use of this network and process in the marketing and advertising industry to virtually setup advertising zones away from immediate vicinity and on potential streets or highways to distribute advertising to specific targets and different time of days;
6) the use of this network and process in the marketing and targeting industry to allow marketers to communicate with a specific target based on past behaviors without revealing any privacy or identities. Example is to target users who like or frequently go to Indian cuisine restaurants;
7) the use of this network and process in the automation industry to automate action upon arrival of the user to a certain location. An example in home automation is to turn on the heat and lights when user approaches his or her house; and
8) the use of such network and process in determining live traffic volume and speeds across a certain region for the purpose of live reporting and traffic redirection.

### CONCLUSIONS

The present invention has been described with regard to one or more embodiments. However, it will be apparent to persons skilled in the art that a number of variations and modifications can be made without departing from the scope of the invention as defined in the claims.

The method steps of the invention may be embodied in sets of executable machine code stored in a variety of formats such as object code or source code. Such code may be described generally as programming code, software, or a computer program for simplification. Clearly, the executable machine code or portions of the code may be integrated with the code of other programs, implemented as subroutines, plug-ins, add-ons, software agents, by external program calls, in firmware or by other techniques as known in the art.

The embodiments of the invention may be executed by a computer processor or similar device programmed in the manner of method steps, or may be executed by an electronic system which is provided with means for executing these steps. Similarly, an electronic memory medium such as computer diskettes, hard drives, thumb drives, CD-Rums, Random Access Memory (RAM), Read Only Memory (ROM) or similar computer software storage media known in the art, may be programmed to execute such method steps. As well, electronic signals representing these method steps may also be transmitted via a communication network.

All citations are hereby incorporated by reference.

What is claimed is:

1. A communication system, comprising:
a first user communication device associated with a first user;
a second user communication device associated with a second user;
a communication network; and
means for translating communication between the first and second users so as to be carried over the network.

2. The communication system of claim 1 wherein said second user is associated with a number of communication devices and said system further comprises means for determining which one of said number of communication devices, said communication should be routed to.

3. The communication system of claim 2, wherein each of the number of communication devices is associated with a communication endpoint selected from a PSTN number, a mobile number, an email address, a SIP URL, a social network ID, and an IP address.

4. The communication system of claim 1 wherein said communication network includes an Internet communication network, and said means for translating communication comprises a server on said Internet communication network.

5. The communication system of claim 4 wherein the server stores all of communication endpoints of the users and their corresponding geolocations, the communication endpoints and their corresponding geolocations being kept under a unique Universal Identification Number (UIN) of the respective user.

6. The communication system of claim 1 wherein said means for translating communication comprises:
a translating server on said communication network;
on said first user communication device, means for encapsulating a request for communication into a message directed to said translating server; and
said translating server being operable to read said message and to extract said request for communication.

7. The communication system of claim 1 wherein said first user communication device is a smart phone.

8. The communication system of claim 1, wherein the communication is a long distance call.

9. The communication system of claim 1, wherein the first user communication device is a web phone associated with a social profile of the second user.

10. The communication system of claim 1, wherein the first user communication device generates an interactive communication to be received by users in a vicinity of a geolocation.

11. A method of placing a communication comprising:
on a mobile device:
intercepting a request to place a long distance call, and
encapsulating the request to place a long distance call, in a local call to a point of service;
and
on the point of service:
extracting the long distance call from the local call, and placing the long distance call over a VOID network.

12. A method of geolocation-based advertising comprising:
an advertiser sending a request to issue an advertisement, to a point of service;
said point of service identifying users within a predetermined proximity of said advertiser;
said point of service identifying issuing said advertisement to said users within a predetermined proximity of said advertiser.

13. The method of geolocation-based advertising of claim 12 wherein the advertisement is an interactive communication which allows the receiving users to respond to.
